(19) United States
(12) Patent Application Publication
(10) Pub. No.: US 2024/0354790 A1
(43) Pub. Date: Oct. 24, 2024

(54) System for Optimizing Product Distribution to Retail Outlets

(71) Applicant: Analogy Partners, LLC, Skillman, NJ (US)

(72) Inventors: John Anthony Singarayar, Skillman, NJ (US); Shanil Anthony Singarayar, Allentown, NJ (US); Pathirage Sahan Damsiri Perera, Pannipitiya (LK)

(73) Assignee: Analogy Partners, LLC, Skillman, NJ (US)

(21) Appl. No.: 18/640,227

(22) Filed: Apr. 19, 2024

Related U.S. Application Data
(60) Provisional application No. 63/497,535, filed on Apr. 21, 2023.

(51) Int. Cl. G06Q 30/0203; G06Q 30/0217; G06Q 30/0238

(52) U.S. Cl. CPC G06Q 30/0203; G06Q 30/0218; G06Q 30/0238

(57) ABSTRACT

A system and method for optimizing marketing in retail outlets and distribution to retail outlets. The system may include a merchant network, which may include a merchant database; a shopper database; a brand database; a bank database; a shopper base module; a brand base module; a bank base module; and a merchant base module. The system may further include a bank network, which may include a payment database; and a bank promotion database. The system may further include a brand network, which may include a product database; and a brand promotion database. The system may further include a merchant point of sale (POS) device; a shopper mobile device, including a merchant application; and wherein, the merchant network, bank network, brand network, merchant POS device, and shopper mobile device may be configured to communicate with one or more of each other.

### RELATED APPLICATIONS

This application is related and claims priority to U.S. Provisional Patent Application No. 63/497,535, filed on Apr. 21, 2023 the application of which is incorporate herein by reference in its entirety.

### TECHNICAL FIELD

The present disclosure is generally related to the optimization of distribution, promotion, and payment for products in retail outlets, leveraging technology to understand customer preferences (forward looking) vs (past behavior). The invention encompasses systems and methods for facilitating customer check-ins at merchant locations via mobile devices, delivering co-promoted offers from brands and banks, and enabling shoppers to provide feedback in exchange for discounts, rewards, or payments. Additionally, the invention incorporates the assessment of creditworthiness for both merchants and shoppers through co-promotion between banks and brands, identifying opportunities to offer loans, payment, and other services while enhancing the understanding of customer preferences.

### BACKGROUND

A Kirana store, also known as a mom-and-pop store, is a small, retail outlet commonly found in India, which primarily sells essential household goods, groceries, and other daily necessities. These stores are typically family-owned and operated, serving local communities with a personalized touch. Kirana stores play a vital role in the Indian retail sector, catering to customers' daily needs in both urban and rural areas.

Small retail stores, such as Kirana stores in India, are vital in providing essential goods and services to their communities. However, these stores face numerous challenges that impact their ability to compete and grow. One significant challenge is the competition from large retail chains and e-commerce platforms, which can offer a wider variety of products, lower prices, and more convenient shopping experiences. The resources and economies of scale of these larger competitors make it difficult for small stores to keep up. Another challenge these small retailers face is limited access to credit and capital. This lack of access hinders their ability to invest in infrastructure, technology, and inventory management, leading to a lack of modernization and exacerbating the competition problem.

Furthermore, informal credit sources can be expensive and unreliable, limiting their growth potential. Small retail stores, such as Kirana stores, often grapple with supply chain inefficiencies, causing issues with inventory management, stockouts, and spoilage. They also may have other operating inefficiencies such as poor work processes and staff practices. These inefficiencies can result in lost sales and decreased profitability. Additionally, many small stores do not have the investment capacity to buy technology, or the expertise to optimize their inventory and supply chain management.

This retail model has four major stakeholders: merchants, brands, banks/payment providers, and consumers. These stakeholders have different objectives in the market. Merchants need low-cost loans, business services, the ability to accept electronic payments, and buying and selling more products. Brands need effective in-store displays, brand loyalty, and a way to effectively measure ROI on marketing. Banks need to acquire more merchants, improve their merchant discount rate, efficiently evaluate the creditworthiness of consumers and merchants, and process a greater percentage of payments. Consumers need ways to save on purchases, access to low-interest cards and electronic payment methods, personalized shopping experiences, and ways to give meaningful feedback to brands, banks, and merchants.

What is needed is a comprehensive solution that addresses the challenges faced by small retail stores, such as Kirana stores and similar stores while considering the distinct needs of the four major stakeholders in the retail model: merchants, brands, banks/payment providers, and consumers.

### SUMMARY

In one embodiment, a system for optimizing marketing in retail outlets and distribution to retail outlets is provided. The system may include . . . .

In another embodiment, a method for optimizing marketing in retail outlets and distribution to retail outlets is provided. The method may include . . . .

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates an example of a system for optimizing the distribution of products to small retail outlets, according to an embodiment.

FIG. 2 illustrates a shopper base module, in accordance with an embodiment of the invention;

FIG. 3 illustrates a greeting module, in accordance with an embodiment of the invention;

FIG. 4 illustrates a shopping offers module, in accordance with an embodiment of the invention;

FIG. 5 illustrates a payment offers module, in accordance with an embodiment of the invention;

FIG. 6 illustrates a market research module, in accordance with an embodiment of the invention;

FIG. 7 illustrates a brand base module, in accordance with an embodiment of the invention;

FIG. 8 illustrates a marketing module, in accordance with an embodiment of the invention;

FIG. 9 illustrates a distribution module, in accordance with an embodiment of the invention;

FIG. 10 illustrates a bank base module, in accordance with an embodiment of the invention;

FIG. 11 illustrates an offer optimization module, in accordance with an embodiment of the invention;

FIG. 12 illustrates a merchant base module, in accordance with an embodiment of the invention;

FIG. 13 illustrates an inventory module, in accordance with an embodiment of the invention; and

FIG. 14 illustrates a feedback module, in accordance with an embodiment of the invention;

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

The subject matter of the invention may provide a system and method for optimizing product distribution, promotion, and payment through retail outlets by understanding customer self-declared buying preferences and actual patterns. Shoppers may check in to a merchant location with their mobile device and receive co-promoted product offers and payments from brands and banks. Shoppers may also provide feedback to brands, banks, and merchants in exchange for discounts, rewards, and/or payments. Co-promotion between banks and brands allows for assessing the credit worthiness and preferences of both merchant and shopper to identify instances in which loans and payment services can be offered. While doing these, the system understands the customer's buying preferences and patterns.

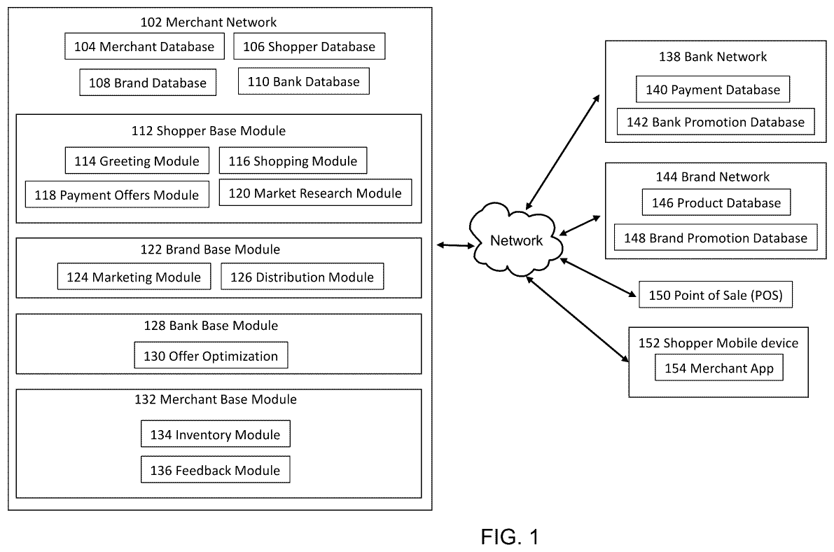

FIG. 1 illustrates a system for optimizing the distribution of products to small retail outlets. This system may include a merchant network 102, that may be an integrated software platform that connects small retail stores, e.g., Kirana and/other similar type/size stores, with banks, brands, and customers to optimize store operations, facilitate lines of credit, and enable personalized marketing. The subject retail stores, such as Kirana and/or other similar type/size stores, wherever located, for case of describing the invention are referred to herein as “merchant stores”. Utilizing artificial intelligence algorithms, the platform identifies relevant offers for consumers and merchants, manages inventory distribution, and provides real-time data-driven insights. Additionally, the merchant network 102 offers a mobile application for customers to receive personalized offers and promotions at small retail stores, access in-store payment options, and provide feedback, further enhancing the shopping experience and driving sales growth for merchants. The system may further include a merchant database 104 that may contain information about registered merchant stores, which may include their store name, location, contact details, KYC (Know Your Customer) data, and the like. This database also may store information on merchants' lines of credit, transaction history, inventory levels, and/or other relevant information. The system may further include a shopper database 106 that may contain information about individual users, such as their name, contact details, preferences, shopping history, any associated bank accounts or payment methods, and/or other relevant information. This database is essential for user authentication, personalization, and providing tailored offers and recommendations. The system may further include a brand database 108 that may contain information about participating brands, which may include their name, logo, product categories, contact details, and/or other relevant information. This database may also maintains data on promotions and offers provided by the brands and their sales performance and feedback. The system may further include a bank database 110 that may contain information about partner banks, including their name, logo, contact details, any associated promotions or offers, and/or other relevant information. This database facilitates, for example, managing bank-specific promotions and incentives and handling lines of credit for merchants. The system may further include a shopper base module 112. Shopper base module 112, provides core functionalities, such as, user authentication, account management, localization, and/or relevant functionalities. This module handles user registration, login, profile management, and basic settings, including, for example, language and notification preferences. Sub-modules within the shopper base module 112 may include user authentication, account management, localization, and/or other like modules. By integrating these modules into the consumer mobile app, the merchant network 102 offers a personalized and engaging experience for users, driving customer loyalty and enhancing the overall shopping experience at merchant stores. The system may further include a greeting module 114. The greeting module 114 may detect when a user, such as a shopper, is near a merchant store registered with the merchant network 102, and may send a push notification or in-app message to greet them upon arrival. The greeting module 114 may include geofencing and personalized greeting functions. The system may further include a shopping offers module 116 that may present users with, for example, personalized offers and/or product recommendations based on their shopping behavior, preferences, and/or store-specific promotions. The system may further include a payment offers module 118 that may allow users to securely complete transactions using the app, and may also present them with relevant bank offers and/or promotions during checkout. This module may incorporate payment integration and/or a bank offer engine. The system may further include a market research module 120 that may enable users, such as a shopper to provide feedback on their shopping experience, rate the offers they received, share suggestions for improvement, and/or provide other information/input. The market research module 120 may include a rating system and feedback submission. The system may further include a brand base module 122, within the merchant network 102 that may serve as a central component for brands to manage their marketing and/or distribution efforts. The brand base module 122 streamlines the process of targeting customers with relevant offers through the marketing module 124 and optimizing product distribution to merchant stores through the distribution module 126, ultimately enhancing the effectiveness of brand strategies in the small retail environment. The system may further include a marketing module 124, which may be a sub-module of the brand base module 122, and which focuses on identifying and delivering tailored offers to individual shoppers based on their preferences and shopping behavior. This module ensures that users (e.g., customers) receive personalized promotions, strengthening the connection between brands and customers while driving customer loyalty and increasing sales. The system may further include a distribution module 126, which may be another sub-module of the brand base module 122, and which aims to optimize the process of getting products to merchant stores. This module efficiently manages product distribution by leveraging data-driven insights and advanced algorithms, amongst other things, ensuring timely deliveries, minimizing stockouts, and/or reducing spoilage. As a result, the distribution module 126 contributes to an improved customer shopping experience and supports merchant stores' overall success. The system may further include a bank base module 128 that may be within the merchant network 102. The bank base module 128 may allow banks to manage their offers and/or financial services directed at individual shoppers and merchants. This module streamlines the process of identifying and delivering relevant offers and lines of credit, enhancing the effectiveness of financial services in the small retail environment. The system may further include an offer optimization module 130 that may be a sub-module of the bank base module 128, and which may focus on utilizing AI to optimize the offers for individual shoppers and merchants. By leveraging advanced algorithms and data-driven insights, the offer optimization module 130 ensures that users receive the most relevant and beneficial offers, thereby fostering stronger connections between banks, customers, and/or merchants while promoting financial inclusion and growth in the small retail sector. The system may further include a merchant base module 132, which may be within the merchant network 102, and which may serve as a central component for merchants to manage their inventory, offers, and shopper engagement. This module preferably streamlines the process of adding new shoppers to the network and utilizes the inventory optimization module 134 and the feedback module 136 to enhance the overall efficiency and effectiveness of the merchant store's retail operations. Through these sub-modules, merchants can optimize inventory management, minimize stockouts, reduce spoilage, and provide feedback on offers directed at the merchant and shoppers, ultimately improving their retail operations. The system may further include an inventory module 134, which may be a sub-module of the merchant base module 132, and which focuses on automatically optimizing ordering for the merchant. By leveraging advanced algorithms and data-driven insights, the inventory module 134 provides timely and efficient inventory management, minimizing stockouts, and reducing spoilage, thereby contributing to an improved shopping experience for customers and increased profitability for merchant stores. The system may further include a feedback module 136, which may be another sub-module of the merchant base module 132, and which enables merchants to provide feedback on offers they and their shoppers receive. The feedback module 136 allows merchants to share their insights on the effectiveness of offers, enabling brands and banks to refine their promotional strategies and tailor future offers to better suit the needs and preferences of merchants and shoppers. The system may further include a bank network 138, which may be within the merchant network 102. The bank network 138 may consolidate information from one or more payment providers. By integrating data from multiple sources into the payment database 140 and the bank promotion database 142, the bank network 138 facilitates seamless interaction between the merchant network 102 and the payment providers, enabling the system to offer a comprehensive and efficient experience for users, merchants, and banks. The system may further include a payment database 140, which may be an element of the bank network 138, and which may contain transactional data, payment method details, and/or other relevant financial information from the payment providers. Payment database 140 enables the merchant network 102 and its modules, such as the payment offers module 118 and the offer optimization module 130, to access and analyze payment data, thereby improving the accuracy and effectiveness of offer targeting, creditworthiness assessments, and other financial services provided by the system. The system may further include a bank promotion database 142, which may be another component of the bank network 138, and which may contain information on various bank promotions, incentives, and/or offers targeted at shoppers and merchants. By making such data available to the merchant network 102 and its modules, for example, the shopping offers module 116 and the payment offers module 118, the system can effectively present users with relevant bank offers during the shopping and checkout processes, promoting financial inclusion and fostering stronger connections between banks, customers, and merchants in the small retail sector. The system may further include a brand network 144, which may contain information related to products and promotions from various brands, such as Unilever, P&G, etc. The brand network 144 facilitates seamless interaction with the merchant network 102, allowing brands to better communicate their offers and product information, and enabling the system to provide a more comprehensive and efficient experience for users, merchants, and brands. The system may further include a product database 146, an element of the brand network 144, which may contain product data, descriptions, and other relevant brand information. This database enables the merchant network 102 and its modules, such as the shopping offers module 116 and the distribution module 126, to access and analyze product data, thereby improving the effectiveness of product recommendations, inventory management, and distribution optimization provided by the system. The system may further include a brand promotion database 148, which may be another component of the brand network 144, and which may contain information on various brand promotions, incentives, and offers targeted at shoppers and merchants. By making this data available to the Merchant network 102 and its modules, for example the shopping offers module 116 and the marketing module 124, the system can effectively present users with relevant brand offers during the shopping process, promoting brand loyalty and fostering stronger connections between brands, customers, and merchants in the small retail sector. The system may further include a point of sale (POS) device 150, which may be installed at one or more locations within each merchant's store. The POS device 150 may serve all the standard functions of a traditional POS system, such as processing transactions, managing inventory, and recording sales data. In addition, the POS device 150 may be equipped with beacons or other proximity-sensing technologies that can detect the presence of shopper mobile devices within the store. Upon detecting a shopper's mobile device, the POS device 150 may trigger the activation of the shopper base module 112, initiating the personalized shopping experience provided by the merchant network 102, and enhancing the overall retail experience for both the shopper and the merchant. The system may further include a shopper mobile device 152, which may serve as the primary interface for shoppers to interact with the merchant network 102. The shopper mobile device 152 may be any portable device, such as, but not limited to, a smartphone or tablet, that the shopper uses to access the merchant app 154. The system may further include a merchant app 154, which may be installed on the shopper mobile device 152. The merchant app 154 facilitates the personalized shopping experience by enabling the user to receive customized offers, product recommendations, and/or other features provided by the merchant network 102 and its modules. By utilizing the shopper mobile device 152, the shopper can seamlessly engage with the merchant network 102, enhancing the overall retail experience and promoting customer loyalty to the merchant stores. The various modules and/or applications of the system may be software applications that may be implemented as a web application and run in a web browser, such as, but not limited to Google Chrome or Microsoft Edge.

Merchant network 102, bank network 138, brand network 144, POS 150, and/or shopper mobile device 152 may be in communication with on another via a communications network. The communications network may be, for example, a local area network (LAN) and/or a wide area network (WAN) for connecting to the Internet or to an Intranet. Further, the communications network may be a cellular internet connection. Merchant network 102, bank network 138, brand network 144, POS 150, and/or shopper mobile device 152 may connect to the communications network by any wired and/or wireless means.

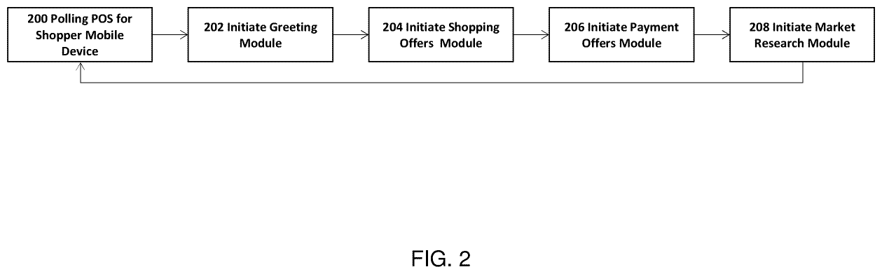

FIG. 2 illustrates the shopper base module 112, which provides core functionalities such as user authentication, account management, and localization. The shopper base module 112 monitors, at step 200, POS devices 150 for the presence of shopper mobile devices 152 in proximity, using the device's built-in beacons or other proximity-sensing technologies. Upon detecting a shopper mobile device 152, the shopper base module 112 initiates, at step 202, the greeting module 114, which may include geofencing and/or personalized greeting functions. For example, when a user approaches a merchant store registered with the merchant network 102, the module sends a push notification or in-app message to greet them upon arrival. After greeting the user, the shopper base module 112 activates, at step 204, the shopping offers module 116, which presents users with personalized offers and product recommendations based on their shopping behavior, preferences, and store-specific promotions. For example, a user may receive a discount on their favorite snack when visiting the store. Once the user has selected their items, the shopper base module 112 triggers, at step 206, the payment offers module 118, which allows users to securely complete transactions using the app while presenting them with relevant bank offers and/or promotions during checkout, such as cashback or loyalty points. Following the completion of the transaction, the shopper base module 112 may initiate, at step 208, the market research module 120. This module may enable users to provide feedback on their shopping experience, rate the offers they received, and/or share suggestions for improvement. Users may rate the store's cleanliness, customer service, overall satisfaction with the shopping experience, and/or other items. By sequentially initiating these modules, the shopper base module 112 guides the user through a personalized and engaging shopping experience at merchant stores, driving customer loyalty and enhancing the overall retail experience.

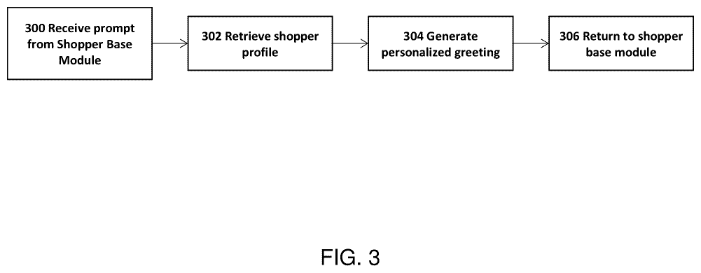

FIG. 3 illustrates the greeting module 114, which detects when a user, e.g., Alice, is near a merchant store registered with the merchant network 102 and sends a push notification or in-app message to greet her upon arrival. This module may include personalized greeting functions. The greeting module 114 receives, at step 300, a prompt from the shopper base module 112, indicating the presence of Alice's shopper mobile device 152 in proximity to a POS device 150 at the merchant store. Upon receiving the prompt, the greeting module 114 may retrieve, at step 302, Alice's profile information from the shopper database 106, including, for example, her name, preferences, and/or shopping history. Using this information, the greeting module generates a personalized greeting message, which may include, for example, Alice's name, store-specific promotions, and/or special offers based on her shopping history. For example, Alice might have a preference for organic products, and the greeting message may include a promotion for 20% off organic items at the store. At step 304, the greeting module 114 may send the generated personalized greeting message as a push notification or in-app message to Alice's shopper mobile device 152, welcoming her upon her arrival at the merchant store. Finally, the greeting module 114 may return, at step 306, to the shopper base module 112, signaling the completion of the greeting process and allowing the shopper base module to proceed with the next steps in Alice's shopping experience.

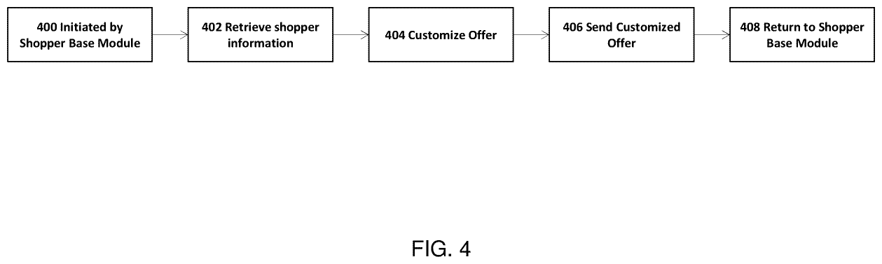

FIG. 4 illustrates the shopping offers module 116, which presents users with personalized offers and product recommendations based on their shopping behavior, preferences, and/or store-specific promotions. The shopping offers module 116 may be initiated by the shopper base module 112 at step 400 after receiving information that a user, e.g., Alice, is near a merchant store. At step 402, the shopping offers module 116 retrieves Alice's profile information, including her preferences and shopping history, from the shopper database 106. It also gathers relevant store-specific promotions and offers from the brand promotion database 148 and the bank promotion database 142. For example, Alice's shopping history indicates a preference for organic products, and there might be a promotion for 20% off organic items at the store. At step 404, the shopping offers module 116 processes the gathered data, which may involve the use of a recommendation engine that may incorporate artificial intelligence algorithms, such as machine learning or deep learning, to create personalized offers and product recommendations tailored to Alice's preferences and shopping history. In this case, the module could leverage the AI algorithms to analyze Alice's past purchases and identify patterns, subsequently recommending organic items on sale and suggesting complementary products based on her previous purchases, such as a new organic snack or beverage. At step 406, the shopping offers module 116 may send the personalized offers and/or product recommendations to Alice's shopper mobile device 152, displaying them within the merchant app 154 as she navigates the store. As Alice explores the store, she can view these personalized offers and recommendations on her device, helping her discover new products and take advantage of relevant promotions. At step 408, the shopping offers module 116 returns to the shopper base module 112, signaling the completion of the personalized shopping offers process and allowing the shopper base module 116.

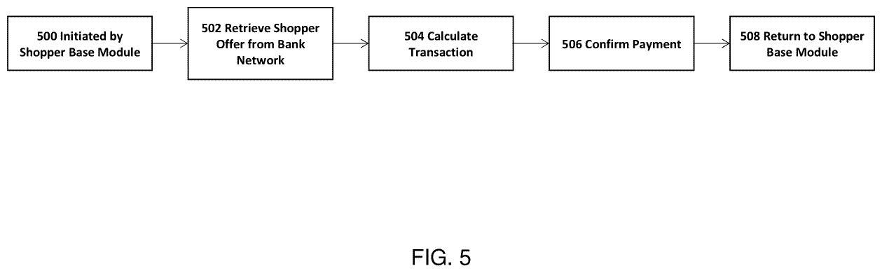

FIG. 5 illustrates the payment offers module 118, which may allow users to securely complete transactions using the app while also presenting them with relevant bank offers and promotions during the checkout process. The payment offers module 118 may be initiated by the shopper base module 112 at step 500 after a user, e.g., Alice, has completed shopping and is ready to pay for her items. At step 502, the payment offers module 118 may communicate with the bank network 138 to access the payment database 140 and the bank promotion database 142. The payment offers module 118 may retrieve Alice's payment preferences and banking information stored in the payment database 140 and any applicable bank offers and promotions from the bank promotion database 142. For example, Alice may have linked her credit card to the merchant app 154, and her bank may offer a 10% cashback promotion on purchases made at merchant stores. At step 504, the payment offers module 118 processes the gathered data, calculating the final amount due, including applicable discounts, taxes, and promotional offers. The module displays the calculated amount, and applicable bank offers to Alice on her shopper mobile device 152 through the merchant app 154. In this case, the module calculates the total amount, considering the 20% off promotion on organic items and the 10% cashback offer from Alice's bank. At step 506, Alice confirms the payment through the app, and the payment offers module 118 securely processes the transaction, integrating with the payment gateway 140 on the bank network 138 to transfer the funds from Alice's bank account or credit card to the merchant store's account. Upon successful completion of the transaction, the payment offers module 118 may generate a digital receipt and sends it to Alice's shopper mobile device 152. At step 508, the payment offers module 118 returns to the shopper base module 112, signaling the completion of the payment process and allowing the shopper base module to proceed with the next steps in Alice's shopping experience, such as proceeding to the market research module 120 for feedback and ratings.

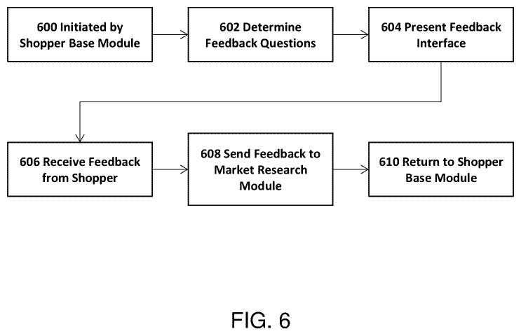

FIG. 6 illustrates the market research module 120, which may enable users to provide feedback on their shopping experience, rate the offers they received, and share suggestions for improvement. The market research module 120 may be initiated by the shopper base module 112 at step 600 after a user, e.g., Alice, has completed her payment process through the payment offers module 118. At step 602, the market research module 120 determines which questions to present to Alice based on her shopping experience, the personalized offers she received, and/or the bank promotions applied during her transaction. The module takes into account the products purchased, the promotions used, and/or Alice's shopping history to tailor the questions accordingly. For example, Alice may be asked to rate her overall shopping experience on a scale of 1 to 5 stars, provide feedback on the 20% off promotion on organic items, and comment on the 10% cashback offer from her bank. At step 604, the market research module 120 may present a feedback interface on Alice's shopper mobile device 152 through the merchant app 154, displaying the determined questions. Alice can then provide her ratings and feedback through the merchant app 154. At step 606, Alice may submit her ratings and feedback. The market research module 120 collects and processes this data, aggregating it with feedback from other users to analyze customer satisfaction and identify areas for improvement in the merchant network 102. In this case, Alice may rate her overall shopping experience 4 out of 5 stars, appreciates the 20% off promotion on organic items, and finds the 10% cashback offer from her bank helpful for her purchases. At step 608, the market research module 120 may share the collected data with the marketing module 124. The marketing module 124 then utilizes the brand network 144 and the brand promotion database 148 to identify and analyze trends in user feedback, allowing brands to adjust their promotions and improve their targeting to better serve customers. For example, if multiple users like Alice provide positive feedback on the 20% off promotion on organic items, the marketing module 124 may encourage the brand to continue or expand the promotion, improving customer satisfaction and increasing sales. Finally, at step 610, the market research module 120 may return to the shopper base module 112, signaling the completion of Alice's shopping experience and the end of the user flow.

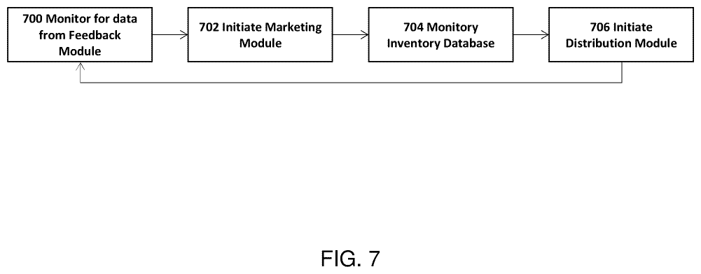

FIG. 7 illustrates the brand base module 122, which may allow for brand-side functionalities within the merchant network 102. The module monitors data from the market research module 120, manages the marketing module 124, and oversees the inventory database 146 and the distribution module 126. At step 700, the brand base module 122 monitors for data from the market research module 120. The module receives feedback, ratings, and suggestions provided by users, such as Alice, during their shopping experiences at merchant stores. This data may be used to identify trends and areas for improvement, informing brands on how to better serve customers. For example, the brand base module 122 may detect that many users appreciate a specific promotion on organic items and would like to see more similar offers. At step 702, upon receiving data from the market research module 120, the brand base module 122 may initiate the marketing module 124. The marketing module 124 may analyze the collected data to develop and adjust marketing strategies, leveraging the brand network 144 and the brand promotion database 148 to optimize promotions for target customers. Continuing the example, the marketing module 124 may encourage the brand to continue or expand the promotion of organic items based on positive user feedback. At step 704, the brand base module 122 monitors the inventory database 146, keeping track of stock levels and product availability across the merchant stores. The brand base module 122 identifies when inventory levels are low or specific products are in high demand, triggering restocking actions to ensure product availability and customer satisfaction. For example, the brand base module 122 may notice that the stock of organic items is running low at a particular merchant store due to the promotion's success. At step 706, when the brand base module 122 identifies a need for restocking or adjusting inventory levels, it initiates the distribution module 126. The distribution module 126 is responsible for coordinating the replenishment of products at merchant stores, ensuring timely and efficient delivery to maintain optimal inventory levels and meet customer demand. In this case, the distribution module 126 would coordinate with the relevant brand and distributor to replenish the stock of organic items at the merchant store, ensuring that customers continue to benefit from the promotion and have access to their desired products.

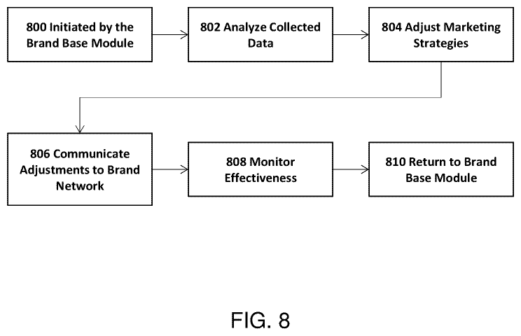

FIG. 8 illustrates the marketing module 124, which may allow for the development and optimization of promotional strategies for brands within the merchant network 102. The module considers, for example, feedback from individual shoppers and cohorts of similar shoppers to identify the most effective offers and tailor them to target customers. At step 800, the marketing module 124 may be initiated by the brand base module 122 upon receiving data from the market research module 120. The data may consist of feedback, ratings, and/or suggestions from users and shopper cohorts, which are groups of users with similar shopping behaviors, preferences, and/or demographics. At step 802, the marketing module 124 analyzes the collected data to identify trends, patterns, and/or areas of improvement. The module may employ data analytics and, in some cases, artificial intelligence to study individual shopper feedback and the preferences of cohorts, gaining insights into the types of offers and promotions that resonate with different customer segments. For example, the module might identify that a cohort of health-conscious shoppers responds positively to promotions on organic products, with a correlation coefficient of 0.85, surpassing a predetermined threshold of 0.8. In another example, the module may recognize a strong correlation between shoppers who frequently purchase baby products and a preference for promotions on diapers, with a correlation coefficient of 0.9, also above the threshold of 0.8. Based on this analysis, the module might suggest introducing a “buy two, get one free” diaper promotion for the identified cohort, expecting a 25% increase in diaper sales among the target audience. Additionally, based on shopper feedback, the module may discover that customers appreciate promotions offering free samples of new products, leading to an increase in the purchase of the promoted items. For instance, the feedback analysis could reveal that 70% of shoppers who tried a free sample of a new cereal brand ended up purchasing the product within the following two weeks. In response to this feedback, the module might suggest implementing free sample promotions for new products that align with the preferences of specific customer segments, such as a new gluten-free cereal for health-conscious shoppers, anticipating a 30% conversion rate from sampling to purchase. At step 804, the marketing module 124 may use the insights from the data analysis to develop or adjust marketing strategies. The module considers the identified trends and preferences to create personalized offers and promotions that cater to the needs and interests of the target customer segments. Decisions to change promotions, adjust cohort membership, or target specific users may be based on correlation coefficient thresholds, indicating a strong relationship between user traits and promotion success. Continuing the examples, the module may recommend that the brand increase the visibility of organic product promotions in-store or through the consumer mobile app to better reach the health-conscious shopper cohort. For the baby products promotion, the module might suggest introducing a “buy two, get one free” diaper promotion for the identified cohort, as the correlation coefficient indicates a strong connection between their shopping behavior and the success of such promotions. At step 806, the marketing module 124 may communicate with the brand network 144 and the brand promotion database 148 to implement and optimize the developed promotions. The marketing module 124 may share the insights gained from shopper feedback and cohort analysis with the relevant brands, ensuring that they are aware of the preferences and expectations of their target customers. At step 808, the marketing module 124 may monitor the effectiveness of the implemented promotions, tracking key performance indicators (KPIs) such as conversion rates, customer engagement, and/or overall satisfaction. The marketing module 124 may continuously evaluates the success of the promotional strategies, iterating and optimizing as necessary to ensure that the promotions remain relevant and appealing to the target customer segments. The monitoring process may work in parallel with the data capture processes of the market research module 120 and the transactional and engagement data collected from the shopper base module 112 and its sub-modules. At step 810, the marketing module 124 may return the updated insights and promotion strategies to the brand base module 122, allowing it to make further adjustments to the overall brand strategy or initiate other brand-related modules as needed. This continuous feedback loop ensures that the brands remain responsive to customer preferences and effectively engage with their target audience.

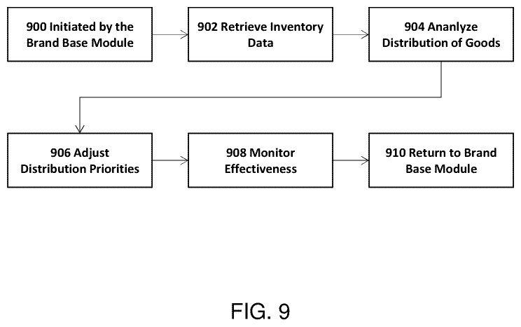

FIG. 9 illustrates the distribution module 126, which may allow optimizing the distribution of products from brands, such as but not limited to, Unilever, to thousands of small merchant stores within the merchant network 102. The module considers changes in the inventory database 146, as well as the traits and preferences of merchants, to prioritize the distribution of goods to maximize sales and profits for the brand and the individual stores. Initiating the distribution module 126 at step 900, the brand base module 122 detects a change in the inventory database 146. The change could be due to a new product introduction, inventory fluctuations, and/or updated stock levels based on store demand. Retrieving data related to the merchants and their stores from the inventory database 146 at step 902, the distribution module 126 obtains information such as store size, location, customer demographics, and/or historical sales data for different products. Analyzing the gathered data at step 904, the distribution module 126 may use artificial intelligence or other advanced techniques to identify patterns and correlations between merchant traits and product distribution efficiency. For example, it may find that smaller stores with a higher percentage of young customers have a higher correlation coefficient (e.g., 0.85) for distributing flavored beverages, making them a higher priority for supplying those products. Based on the analysis, adjusting distribution priorities at step 906, the distribution module 126 updates the distribution plan to optimize the allocation of products to various stores. For instance, it may prioritize supplying a new flavored beverage to smaller stores with a younger customer base, as they have shown a higher affinity for selling similar products in the past. Continuously monitoring the inventory data and looping the process at step 908, the distribution module 126 may compare the real-time data with the distribution plan to identify any deviations or opportunities for further optimization. The distribution module 126 may adjust the distribution plan as necessary to ensure that product distribution remains optimized based on the latest data and insights. Finally, returning to the brand base module 122 at step 910, the distribution module 126 completes its process, allowing the brand base module 122 to continue monitoring the inventory database 146 and initiating other modules as needed.

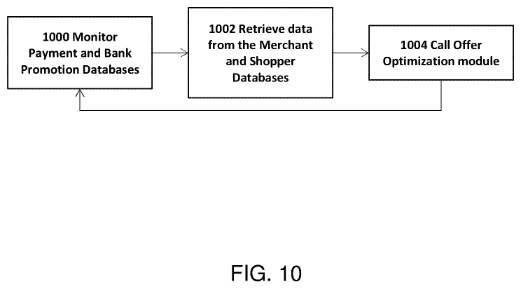

FIG. 10 illustrates the bank base module 128 within the merchant network 102, which may allow banks to manage their offers and financial services directed at individual shoppers and merchants. The bank base module 128 streamlines the process of identifying and delivering relevant offers and lines of credit, enhancing the effectiveness of financial services in the small retail environment. Monitoring the payment database 140 and the bank promotion database 142 at step 1000, the bank base module 128 continuously observes new transactions and promotions from the banks within the bank network 138, looking for triggers such as new offers or changes in customer or merchant profiles. For example, a trigger might be introducing a new credit card offer or a significant change in a merchant's transaction volume. Upon detecting a trigger at step 1002, the bank base module 128 may respond by retrieving relevant data about individual shoppers and merchants from the shopper database 134 and the merchant database 136, such as their financial history, credit scores, and/or demographic data, to determine their eligibility for various financial services and offers. Calling the offer optimization module 130 at step 1004, the bank base module 128 may leverage advanced algorithms and data-driven insights to optimize the offers for individual shoppers and merchants. By utilizing AI, this module ensures that users receive the most relevant and beneficial offers, fostering stronger connections between banks, customers, and merchants while promoting financial inclusion and growth in the small retail sector. Return to step 1000.

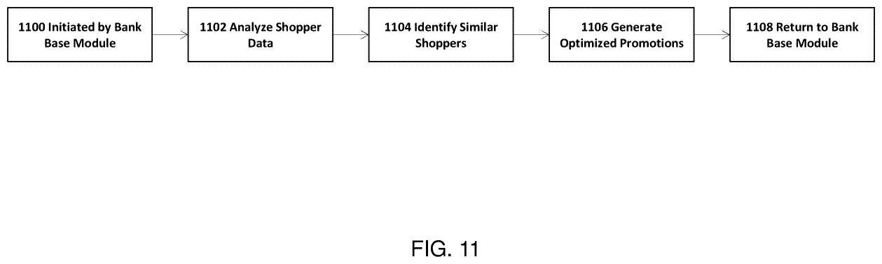

FIG. 11 illustrates the offer optimization module 130, which is a sub-module of the bank base module 128, and which focuses on utilizing AI to optimize the offers for individual shoppers and merchants. By leveraging advanced algorithms and data-driven insights, this module ensures that users receive the most relevant and beneficial offers, fostering stronger connections between banks, customers, and merchants while promoting financial inclusion and growth in the small retail sector. The offer optimization module 130 may be initiated, at step 1100, by the bank base module 128, providing it with the relevant shopper and merchant data obtained from the shopper database 134 and the merchant database 136. In step 1102, the offer optimization module 130 may analyze the retrieved data to determine correlations between shopper behavior, merchant performance, bank benefits, and the success of past offers. For example, the module may identify that shoppers with a preference for a particular brand of detergent are more likely to respond positively to a combined promotion offering a discount on that detergent and an associated bank service, such as a credit card offer with cashback rewards. The module computes correlation coefficients using artificial intelligence, identifying strong relationships among these factors that result in mutually beneficial promotions for the brand and bank. The offer optimization module 130 utilizes, at step 1104, the bank promotion database 142 to store newly created or adjusted offers. The module may compare the correlation coefficients computed in step 1102 to a predefined threshold, such as 0.7, deciding whether an offer should be created, adjusted, or excluded based on the analysis. In step 1106, the offer optimization module 130 may generate and store the optimized co-promotions in the bank promotion database 142. For instance, based on the analysis, the module could create a promotion offering a 20% discount on the identified detergent brand when the shopper applies for a specific credit card from the participating bank. As a second example, the module may recognize that a cohort of shoppers who frequently purchase organic snacks are also likely to be interested in opening a savings account with a green initiative. In this case, the offer optimization module 130 may create a co-promotion offering a bonus interest rate on a new eco-friendly savings account when the shopper buys a bundle of organic snacks from a participating merchant. The offer optimization module 130 returns, at step 1108, to the bank base module 128, which will continue to monitor for triggers and initiate the offer optimization module when necessary, ensuring that the most relevant and beneficial offers are continuously created and updated for individual shoppers and merchants.

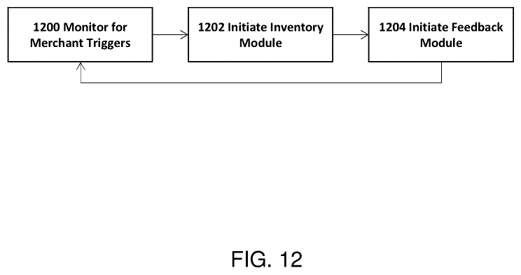

FIG. 12 illustrates the merchant base module 132 within the merchant network 102, which may allow merchants to manage their inventory, offers, and/or shopper engagement. This module streamlines the process of adding new shoppers to the network and utilizes the inventory module 134 and the feedback module 136 to enhance the overall efficiency and effectiveness of merchant store operations. The merchant base module 132 begins, at step 1200, by monitoring for triggers from merchants, such as a request to order new products or provide feedback on promotions. These triggers could be initiated through the merchant's mobile app or a web interface. Upon detecting a trigger related to inventory management, the merchant base module 132 initiates, at step 1202, the inventory module 134, which helps merchants manage their inventory, minimize stockouts, reduce spoilage, and ensure they have the right products in stock to meet shopper demand. The inventory module analyzes the merchant's inventory data and generates recommendations for optimal product orders based on factors such as, but not limited to, sales history, seasonal trends, and/or current stock levels. If the merchant wants to provide feedback on promotions, the merchant base module 132 initiates, at step 1204, the feedback module 136. This module enables merchants to share their thoughts on the effectiveness and relevance of offers directed at merchants and shoppers. The feedback collected helps the system improve the overall shopping experience and tailor promotions to better suit the needs of both merchants and shoppers. After completing the relevant sub-module processes, the merchant base module 132 returns to step 1200, continuing to monitor for new triggers, ensuring that it is always ready to support merchants in managing their inventory, offers, and shopper engagement. Through the continuous operation of this module and its sub-modules, merchants can improve their retail operations and ultimately increase sales and profits.

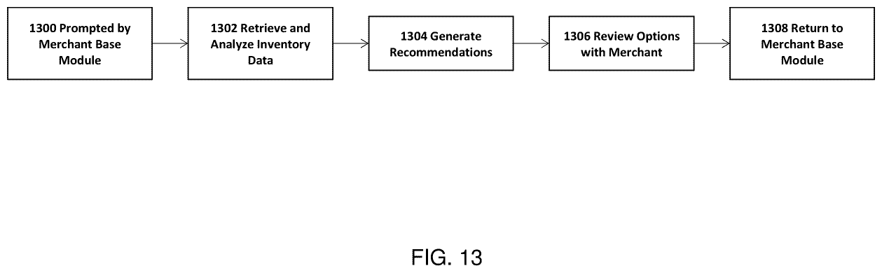

FIG. 13 illustrates the inventory module 134, which may be a sub-module of the merchant base module 132, and which focuses on automatically optimizing ordering for the merchant. By leveraging advanced algorithms and data-driven insights, this module ensures timely and efficient inventory management, minimizing stockouts, and reducing spoilage, thereby contributing to an improved customer shopping experience and increased profitability for merchant stores. The inventory module 134 may be initiated, at step 1300, by the merchant base module 132 upon receiving a trigger related to inventory management from the merchant. At step 1302, the inventory module retrieves and analyzes relevant inventory data from the inventory database 146, including current stock levels, sales history, and product expiration dates. The module may utilize advanced algorithms and data-driven insights to analyze the collected inventory data, considering factors such as historical sales patterns, seasonal trends, and shopper preferences. For example, the inventory module may identify that a particular brand of shampoo has been consistently selling out during the first week of each month, indicating a recurring demand spike. Based on this insight, the module may recommend increasing the order quantity for this product to prevent stockouts. As another example, the module may identify that a certain type of snack experiences a significant increase in sales during the summer months. In response, the module may recommend adjusting the store's inventory by ordering more of that snack in anticipation of the seasonal demand. Based on the analysis, the inventory module 134 may generate, at step 1304, optimal order recommendations for the merchant aimed at minimizing stockouts, reducing spoilage, and ensuring that the store has the right products in stock to meet shopper demand. The inventory module 134 may present, at step 1306, the order recommendations to the merchant via the merchant's mobile app or web interface. The merchant may review the recommendations and make necessary adjustments before confirming the order. Upon confirmation of the order or completion of the inventory management process, the inventory module 134 may return, at step 1308, to the merchant base module 132, which may continue monitoring for new triggers related to inventory management or feedback on promotions, ensuring seamless support for merchants in managing their inventory, offers, and/or shopper engagement.

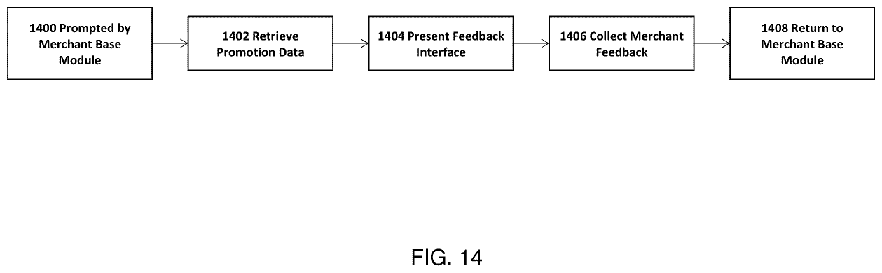

FIG. 14 illustrates the feedback module 136, which may be a sub-module of the merchant base module 132, and which focuses on collecting feedback from merchants regarding their experience with promotions, inventory, and/or shopper engagement. By leveraging this feedback, the system can continuously improve and tailor its services to better meet the needs of the merchants and enhance the overall efficiency of small retail operations. The feedback module 136 may be initiated, at step 1400, by the merchant base module 132 upon receiving a trigger related to providing feedback from the merchant. At step 1402, the feedback module retrieves relevant promotions, inventory, and/or shopper engagement data from the brand promotion database 148 and the bank promotion database 142. This data may include information about past and ongoing promotions, shopper behavior, and/or inventory levels. At step 1404, the feedback module presents the retrieved data to the merchant via the merchant's mobile app or web interface, along with an interface for providing feedback on various aspects of the retail operations. The merchant can then review the data and share their insights, suggestions, and concerns. For example, the merchant might provide feedback on a promotion that did not perform well, suggesting changes to the target audience, discount amount, or product selection. Alternatively, the merchant could report issues with inventory management, such as stockouts or excess stock, which could inform adjustments to future order recommendations. At step 1406, the feedback module collects and processes the merchant's feedback, utilizing it to update the system's algorithms and improve the accuracy and effectiveness of future recommendations, promotions, and inventory management strategies. Upon completion of the feedback process, the feedback module returns, at step 1408, to the merchant base module 132, which continues monitoring for new triggers related to inventory management or providing feedback on promotions, ensuring seamless support for merchants in managing their inventory, offers, and shopper engagements performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The system and method of the invention will facilitate merchants in obtaining low-cost loans, offering business services, accepting electronic payments, and increasing product sales. The system and method of the invention will enhance in-store displays, promote brand loyalty, and enable accurate ROI measurement in marketing for brands. Banks and payment providers will benefit from an increased merchant base, improved merchant discount rates, efficient creditworthiness evaluation, and higher payment processing rates. Consumers will experience savings on purchases, access to low-interest cards and electronic payment methods, personalized shopping experiences, and channels for providing meaningful feedback.

By catering to the specific needs of each stakeholder and addressing the challenges faced by small retail stores, the system and method of the invention ensures the sustainability and growth of merchant stores and similar businesses, contributing to the overall prosperity of local communities. The solution can be applied to various small retail outlets worldwide, including convenience stores, neighborhood bodegas, and corner shops. It should be noted that while the invention was developed around small stores, it is equally effective in larger retail outlets.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

The terms “include,” “includes,” “including,” “include,” “includes,” and “including,” are intended to be non-limiting, such that recitation of items in a list is not to the exclusion of other like items that may be substituted or added to the listed items.

Terms like “preferably,” “commonly,” and “typically” are not utilized herein to limit the scope of the claimed embodiments or to imply that certain features are critical or essential to the structure or function of the claimed embodiments. These terms are intended to highlight alternative or additional features that may or may not be utilized in a particular embodiment of the present disclosure.

The term “substantially” is utilized herein to represent the inherent degree of uncertainty that may be attributed to any quantitative comparison, value, measurement, or other representation and to represent the degree by which a quantitative representation may vary from a stated reference without resulting in a change in the basic function of the subject matter at issue.

Various modifications and variations of the disclosed methods, compositions and uses of the disclosure will be apparent to the skilled person without departing from the scope and spirit of the disclosure. Although the subject matter has been disclosed in connection with specific preferred aspects or embodiments, it should be understood that the subject matter as claimed should not be unduly limited to such specific aspects or embodiments.

The subject matter may be implemented using hardware, software, or a combination thereof and may be implemented in one or more computer systems or other processing systems. In one aspect, the subject matter is directed toward one or more computer systems capable of carrying out the functionality described herein.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A system for optimizing marketing in retail outlets and distribution to retail outlets, including:
a. a merchant network, comprising: a merchant database; a shopper database; a brand database; a bank database; a shopper base module; a brand base module; a bank base module; and a merchant base module;
b. a bank network, comprising: a payment database; and a bank promotion database;
c. a brand network, comprising: a product database; and a brand promotion database;
d. a merchant point of sale (POS) device;
e. a shopper mobile device, comprising a merchant application; and
wherein, the merchant network, bank network, brand network, merchant POS device, and shopper mobile device are configured to communicate with one or more of each other.

2. The system of claim 1, wherein the merchant network, bank network, brand network, merchant POS device, and shopper mobile device are configured to communicate with one or more of each other via a network.

3. The system of claim 2, wherein the merchant POS device is configured to detect the presence of a shopper mobile device within a merchant store, wherein a shopper can check in to the merchant store via the merchant application, and receive offers, rate offers, and/or conduct transactions at the merchant store.

4. The system of claim 3, wherein the merchant POS device comprises beacons and/or proximity sensors configured for detecting the presence of the shopper mobile device within the merchant store.

5. The system of claim 2, wherein the merchant base module is configured to identify shoppers to offer bank and/or brand products and/or services to.

6. The system of claim 1, wherein the bank network is configured to process payments between shoppers, merchants, banks and/or brands.

7. The system of claim 5, wherein the bank base module is configured to identify merchants, shoppers, and/or brands to co-promote products and/or services.

8. The system of claim 1, wherein the brand network is configured to coordinate product delivery to merchants and promotions to shoppers.

9. The system of claim 1, wherein the brand base module is configured to identify shoppers to promote offers on products and/or serves at specific merchants.

10. The system of claim 1, further comprising a market research module configured to request shoppers to rate offers they receive to learn which kinds of offers they prefer for different kinds of products and/or product categories.

11. The system of claim 1, wherein the shopper module is configured to request and collect feedback on merchants, brands, and/or products/services, and is further configured to direct shoppers to promoted brands, products/services, and/or merchants.

12. The system of claim 1, wherein shoppers are provided incentives for stating which brands and/or products/services they prefer, rating brand and/or bank offers they receive, providing feedback on products/services, brands, merchants, and/or banks, and wherein brands and banks promote merchants, products/services to identified customers.

13. A system for optimizing marketing in retail outlets and distribution to retail outlets, comprising:
a. a shopper mobile device;
b. a merchant device that allows a shopper to check in, receive and rate offers and conduct transactions at a merchant location;
c. a merchant module that identifies shoppers to offer co-promoted bank and/or brand products and services;
d. a bank network that processes payments between shoppers, merchants, banks and/or brands;
e. a bank module that identifies merchants, shoppers, and/or brands to co-promote products and services including from banks and/or brands;
f. a brand network that coordinates product delivery to merchants and promotions to shoppers;
g. a communications module that monitors the merchant device for shopper check-in;
h. a brand module that identifies shoppers to promote offers on their products at specific merchants;
i. a brand offer-rating module that asks shoppers to rate offers they receive to learn which kinds of offers they prefer for different kinds of products and/or product categories;
j. a shopper module that delivers surveys, collects feedback on merchants, brands, and products, and directs users to promoted brands, products, and merchants; and
k, wherein the shoppers are compensated for stating which brands and products they prefer, for rating brand and/or bank offers they receive, for providing feedback on products, brands, merchants, and/or banks, so that brands and/or banks may promote merchants, products and/or services to identified customers.
